(19) United States
(12) Patent Application Publication
(10) Pub. No.: US 2024/0012791 A1
(43) Pub. Date: Jan. 11, 2024

(54) SYSTEMS AND METHODS FOR PROCESSING AGGREGATED RECORDS WITH DEDUPLICATION MARKERS

(71) Applicant: FoxIO, LLC, Austin, TX (US)

(72) Inventor: John Brooke ALTHOUSE, Round Hill, VA (US)

(21) Appl. No.: 18/220,258

(22) Filed: Jul. 10, 2023

Related U.S. Application Data
(60) Provisional application No. 63/359,877, filed on Jul. 10, 2022.

(51) Int. Cl. G06F 16/174

(52) U.S. Cl. CPC G06F 16/1748

(57) ABSTRACT

A method of processing aggregated records. An aggregated record is received. A key-value pair is identified within the aggregated record, wherein the key-value pair comprises a key and a value, and wherein the key comprises a deduplication marker. An aggregation method is identified based on a characteristic of the deduplication marker. The aggregated record is processed using an algorithm determined by the aggregation method to produce at least one processed record.

### RELATED APPLICATIONS

This application claims the benefit of U.S. Prov. Pat. App. Ser. No. 63/359,877, filed on Jul. 10, 2022. The contents of each application cited in this paragraph are incorporated by reference as if set forth fully herein.

### BACKGROUND OF THE DISCLOSURE

### Field of the Disclosure

The present disclosure relates generally to systems and methods for processing aggregated records with deduplication markers, especially aggregated computer log records, to improve efficiency in computer system storage and analysis.

### Description of the Related Art

The proliferation of “Big Data” analyses and related applications have made data gathering of significant importance. For example, logging has become ubiquitous for nearly all kinds of computer-related activities, spawning a large amount of computer log data. Organizations around the world extensively accumulate computer log data, hoping to derive value from them. This requires a large volume of storage space to store the computer log data. In addition, querying through the vast amount of computer log data is time consuming, diminishing the value and usefulness of such data.

The advance in Big Data analyses had prompted many organizations to harvest data by logging a wide range of user activities, such as network connection activities, system logging-in/out activities, etc. Such extensive logging operations require a large volume of storage space, imposing a heavy tax on hardware resources. Moreover, the vast amount of data makes information querying slow and inefficient, greatly diminishing the value and usefulness of the data. It is challenging to reduce the volume of the logged data while keeping a high degree of fidelity of the data.

Embodiments of systems and methods for reducing the volume of the computer log data while preserving the information contained therein are discussed in detail in U.S. Pat. No. 10,877,972 to Althouse (“Althouse”), the contents of which are incorporated by reference as if set forth fully herein.

Althouse describes various systems and methods for managing computer log data by deduplicating redundant information from the original data. Exemplary systems and methods can improve the efficiency of computer log data storage, as well as the speed of information querying. For example, embodiments of the disclosure may identify data fields that are duplicative across multiple log records and combine the multiple log records into an aggregated log record. The aggregated log record may contain a single copy of the duplicative contents and an aggregated version of non-duplicative contents extracted from the multiple log records. In this way, the amount of computer log data requiring storage can be significantly reduced.

Log data may be organized as a set of log records. As used herein, a “log record” may also be referred to as a “log entry” or simply a “record,” referring to a unit of information logged at a time point or corresponding to a time stamp. A log record may include a plurality of data fields, including, for example, a time stamp, an ID indicating the user whose activities are logged, an event/action/result relating to the circumstances of the log record, etc.

FIG. 1 illustrates an exemplary system 100 for managing log data, according to embodiments of the disclosure. As shown in FIG. 1, system 100 may include a log producing unit 110, a log processing unit 120, a log storage unit 130, and a log querying unit 140. Log producing unit 110 may include any suitable computer or device configured to produce log data.

Exemplary log producing unit 110 may include a computer programmed to be log use logging-in/out activities, a networked computer programmed to log network connection activities, a mobile device equipped with a geolocation sensor and programmed to log location information, a payment device configured to log financial transactions, an activity tracker configured to log steps, heart rates, blood pressures, etc., or any other device capable of recording information on a periodic or event-triggered basis.

Log storage unit 130 may include any suitable computer, server, database, and service platform (e.g., Splunk developed by Splunk Inc., Elastic Stack [also known as ELK Stack] developed by Elasticsearch B.V., etc.) that are configured/programmed to store log data. In some embodiments, log storage unit 130 may be implemented as a separate component from log producing unit 110. For example, log storage unit 130 may be implemented on a separate computer from that of log producing unit 110. In some embodiments, log storage unit 130 may be integrated with log producing unit 110. For example, the functions of log producing unit 110 and log storage unit 130 may be implemented by software packages installed on the same computer.

Log processing unit 120 may include a computer system programmed to process the log data produced by log producing unit 110 and/or stored in log storage unit 120. FIG. 1 illustrates several examples of log data flows among log producing unit 110, log processing unit 120, and log storage unit 130. As shown in FIG. 1, log data produced by log producing unit 110 (also referred to as original log data) may be sent directly to log storage unit 130 for storage along path A. After log storage unit 130 receives the original log data from log producing unit 110, log storage unit 130 may store the original log data without calling log processing unit 120. After that, log processing unit 120 may access the original log data stored in log storage unit 130 by, for example, retrieving the original log data from log storage unit 130 along path D, process the original log data to reduce the size of the original log data using methods disclosed in Althouse, and send the processed log data back to log storage unit 130 along path E to replace the original log data stored in log storage unit 130. In this way, log processing unit 120 may reduce the size of existing log data stored in any log storage system. In the following, log processing in this manner (e.g., log data flow along paths D and E) is also referred to as historical log data processing.

In some embodiments, log processing unit 120 may be configured to process original log data produced by log producing unit 110 before the original log data reach log storage unit 130. For example, log processing unit 120 may be located between log producing unit 110 and log storage unit 130. In other words, log processing unit 120 may be located upstream to log storage unit 130 to process the incoming original log data produced by log producing unit 110 before the original log data reach log storage unit 130. As shown in FIG. 1, the original log data may be sent from log producing unit 110 to log processing unit 120 along path B. After log processing unit 120 processes the original log data (e.g., to reduce the data size), the processed log data may be sent from log processing unit 120 to log storage unit 130 along path C. In the following, log processing in this manner (e.g., log data flow along paths B and C) is also referred to as inline log data processing.

Log querying unit 140 may include any suitable computer, terminal, mobile device, etc. that is programmed to query log data stored in log storage unit 130. In some embodiments, log query unit 140 may query log storage unit 130 directly along path J. When log storage unit 130 stores processed log data processed by log processing unit 120, the volume or size of the processed log data can be significantly smaller than that of original log data, allowing the query to traverse through the processed log data much faster, thereby improving data querying speed. The result of the query (e.g., one or more processed log records that satisfy query condition(s)) may be returned from log storage unit 130 to log querying unit 140 along path K. In some embodiments, log querying unit 140 may query log data through log processing unit 120. For example, a request for retrieving log records that satisfy certain query conditions may be sent from log querying unit 140 to log processing unit 120 along path F. Log processing unit 120 may in turn send the request to log storage unit 130 along path G to locate the log records. In this case, log storage unit 130 may or may not store log data in the processed form. For example, log storage unit 130 may store original log data, or store a combination of original and processed log data. In any case, the log data satisfying the query conditions may be retrieved from log storage unit 130 and sent to log processing unit 120 along path H. Log processing unit 120 may process the received log data when needed, and send the processed log data to log querying unit 140 along path I.

In some embodiments, log processing unit 120 may be implemented as a stand-alone device that includes its dedicated computational resources, which may interface with other components of system 100 (e.g., 110, 130, 140) through communication channel(s) (e.g., network connections, direct cable connections, etc.). For example, log processing unit 120 may be implemented on a server and functions of log processing unit 120 may be implemented as Software as a Service (SaaS). In some embodiments, log processing unit 120 may be implemented as an add-on device that can be integrated with or added on to one or more other components of system 100 (e.g., 110, 130, 140). For example, log processing unit 120 may be implemented on a smart card, a system on a chip (SoC), or other forms of add-on or plugged-in devices that can be integrated with log producing unit 110, log storage unit 130, and/or log querying unit 140. In some embodiments, log processing unit 120 may use hardware resources of one or more other components of system 100 (e.g., 110, 130, 140). For example, log processing unit 120 may be implemented as a software program that can be installed on log producing unit 110 and/or log storage unit 130 to perform historical and/or inline log data processing. In some embodiments, log processing unit 120 may be implemented as a combination of the above discussed forms. For example, log processing unit 120 may be implemented as a SaaS with a plug-in program acting as a communication portal installed on log producing unit 110, log storage unit 130, and/or log querying unit 140.

For consumers of deduplicated log files, e.g., providers of security information and event management (“SIEM”) services and products, there is a need for systems and methods capable of processing incoming aggregated records.

### SUMMARY OF THE DISCLOSURE

These and other further features and advantages of the invention would be apparent to those skilled in the art from the following detailed description, taken together with the accompanying drawings.

### BRIEF DESCRIPTION OF THE DRAWINGS

FIG. 1 is an exemplary system for managing computer log data, according to the related art.

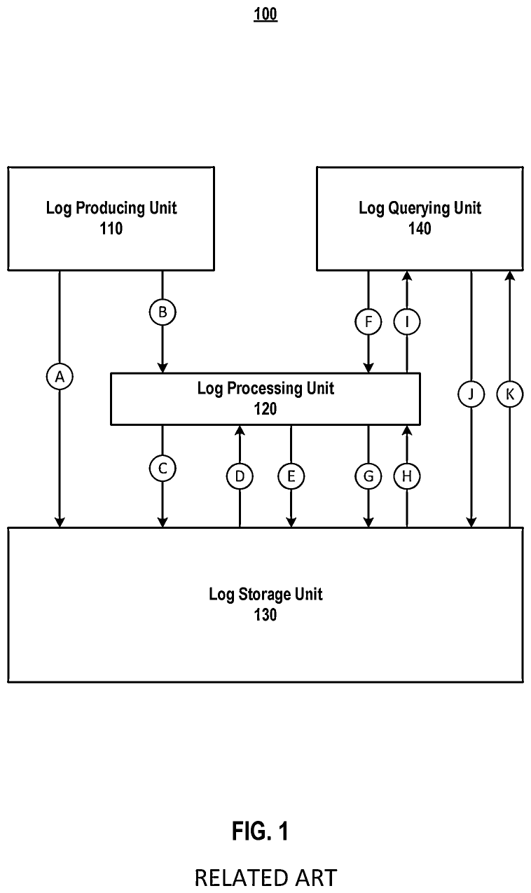

FIG. 2 is a flowchart of an exemplary method for processing aggregated records according to embodiments of the present disclosure.

The features and advantages of the various exemplary embodiments will become apparent from the following detailed description when considered in conjunction with the accompanying drawings. Where possible, the same reference numerals and characters are used to denote like features, elements, components or portions of the inventive embodiments. It is intended that changes and modifications can be made to the described and shown exemplary embodiments without departing from the true scope and spirit of the inventive embodiments described herein as defined by the claims.

### DETAILED DESCRIPTION OF THE DISCLOSURE

Throughout this description, preferred embodiments and examples illustrated should be considered as exemplars, rather than as limitations on the present invention. As used herein, the term “invention,” “device,” “method,” “disclosure,” “present invention,” “present device,” “present method,” or “present disclosure” refers to any one of the embodiments of the invention described herein, and any equivalents. Furthermore, reference to various feature(s) of the “invention,” “device,” “method,” “disclosure,” “present invention,” “present device,” “present method,” or “present disclosure” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. It is also understood that when an element is referred to as being “attached,” “connected” or “coupled” to another element, it can be directly attached, connected or coupled to the other element or intervening elements may be present. In contrast, when an element is referred to as being “directly attached,” “directly connected” or “directly coupled” to another element, there are no intervening elements present.

Relative terms such as “outer,” “above,” “lower,” “below,” “horizontal,” “vertical” and similar terms, may be used herein to describe a relationship of one feature to another. It is understood that these terms are intended to encompass different orientations in addition to the orientation depicted in the figures.

Although the terms first, second, etc., may be used herein to describe various elements, components, or steps, these elements, components, or steps should not be limited by these terms. These terms are only used to distinguish one element, component, or step from another element, component, or step. Thus, a first element or component discussed below could be termed a second element or component without departing from the teachings of the present disclosure. As used herein, the term “and/or” includes any and all combinations of one or more of the associated list items.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “having,” and similar terms, when used herein, specify the presence of stated features, integers, steps, operations, elements, and/or components, but do not preclude the presence or addition of one or more other features, integers, steps, operations, elements, components, and/or groups thereof.

In computing, data deduplication is a technique for eliminating duplicate copies of repeating data. Successful implementation of the technique can improve storage utilization, which may in turn lower capital expenditure by reducing the overall amount of storage media required to meet storage capacity needs. It can also be applied to network data transfers to reduce the number of bytes that must be sent.

A deduplication marker is an identifier which indicates the duplication of data records such as, for example, a count of aggregated log records as described in detail in U.S. Pat. No. 10,877,972 to Althouse, which has been incorporated by reference herein. Embodiments of the present disclosure include systems and methods for processing aggregated records based on the deduplication marker.

Some log tools perform counts and actions on the number of key-value pairs in log records. For example, if the key-value pair of ‘domain=google.com’ occurs in 100 log lines, the tool will indicate that ‘domain=google.com’ occurs 100 times.

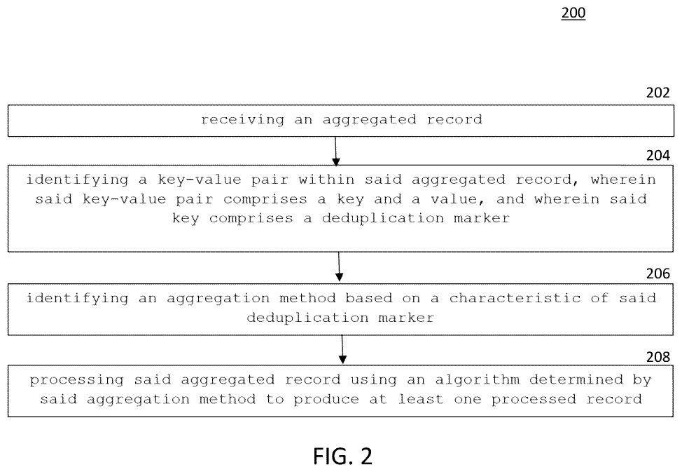

FIG. 2 is a flowchart of a method of processing aggregated records 200 according to an embodiment of the present disclosure. An aggregated record is received 202. A key-value pair is identified within the aggregated record, wherein the key-value pair comprises a key and a value, and wherein the key comprises a deduplication marker 204. An aggregation method is identified based on a characteristic of the deduplication marker 206. The aggregated record is processed using an algorithm determined by the aggregation method to produce at least one processed record 208.

With aggregated log records, for example, ‘domain=google.com’ may appear in one log line with a deduplication marker value of 100, meaning that the key-value pair occurred 100 times but is only being stored once to save storage space and increase processing efficiency.

A log processing tool will need to identify the deduplication marker either by name, identifier, or configuration. To maintain the integrity of the data within these logs, the tool will then need to process the target key-value pairs according to their aggregation method, which can be identified by either name, identifier, or configuration. Table 1 below shows an exemplary collection of non-aggregated log records.

TABLE 1
Exemplary Non-Aggregated Log Records

| timestamp | host | srcport | type | domain | dstip | dstport | proto | bytes | | action |
|---|---|---|---|---|---|---|---|---|---|---|
| 08:12:01 | bob-ws1 | 2560 | connection | mail.google.com | 172.217.15.101 | 443 | tls | 104 | kb | Action: Allow |
| 08:12:04 | bob-ws1 | 2570 | connection | mail.google.com | 172.217.15.101 | 443 | tls | 128 | kb | Action: Allow |
| 08:12:25 | bob-ws1 | 2580 | connection | mail.google.com | 172.217.15.101 | 443 | tls | 256 | kb | Action: Allow |
| 08:12:40 | bob-ws1 | 4567 | connection | evil.malware.su | 129.2.15.1 | 443 | tls | 1 | kb | Action: Block |
| 08:12:33 | bob-ws1 | 2790 | connection | mail.google.com | 172.217.15.101 | 443 | tls | 512 | kb | Action: Allow |
| 08:12:33 | bob-ws1 | 2560 | connection | mail.google.com | 172.217.15.101 | 443 | tls | 523 | kb | Action: Allow |
| 08:12:33 | bob-ws1 | 2540 | connection | mail.google.com | 172.217.15.101 | 443 | tls | 532 | kb | Action: Allow |
| 08:12:33 | bob-ws1 | 2598 | connection | mail.google.com | 172.217.15.101 | 443 | tls | 542 | kb | Action: Allow |
| 08:12:54 | bob-ws1 | 2600 | connection | mail.google.com | 172.217.15.101 | 443 | tls | 768 | kb | Action: Allow |

The example aggregate record shown in Table 2 below may be generated according to an embodiment of the presently disclosed methods.

TABLE 2
Exemplary Aggregated Logs

| | timestamp- | | | | | | | | bytes- | | | |
|---|---|---|---|---|---|---|---|---|---|---|---|---|
| timestamp | end | host | srcport | type | domain | dstip | dstport | proto | total | | action | logslash |
| 08:12:01 | 08:12:54 | bob-ws1 | | connection | mail.google.com | 172.217.15.101 | 443 | tls | 3365 | kb | Action: Allow | 8 |
| 08:12:40 | 08:12:40 | bob-ws1 | 4567 | connection | evil.malware.su | 129.2.15.1 | 443 | tls | 1 | kb | Action: Block | 1 |

In this example, for the deduplication marker key-value pair ‘logslash=8’, the key is the field name ‘logslash’, which in this case is the deduplication marker, and the value is eight (8). Logs may be stored in this format to save space and reduce search time and processing costs. However, for the purposes of reporting, graphing, or processing, target key-value pairs can be expanded using an algorithm which is determined by the original aggregation method as indicated by the deduplication marker.

For key-value pairs with no additional identifiers, the default process may be to duplicate a particular key-value pair by the deduplication marker value. In the above example, ‘domain=mail.google.com’ (the target key-value pair) appears in a log line with ‘logslash=8’ (the deduplication marker key-value pair), which indicates a value of eight (8); therefore, the system could duplicate ‘domain=mail.google.com’ eight (8) times within the aggregation window for reporting, graphing, or processing.

For target key-value pairs with additional identifiers in the key, like “−total”, a different method of processing the target key-value pair against the deduplication marker may be required. In this example, “bytes-total=3365 kb”, indicates that the byte values from the original non-aggregated records were summed. For reporting, graphing, or processing purposes, the system could divide the sum by the deduplication marker value, thus reporting or graphing that each log line averaged approximately 420 kb over eight (8) connections (3365 kb÷8 connections≈420 kb/connection) within the aggregation time window.

Log file deduplication techniques can significantly reduce the amount of processing, and therefore equipment, power, space, etc, needed to train artificial intelligence (“AI”) models on data. To do this, the AI model would need to consider the deduplication technique used and how to handle its deduplication marker. For example, the model could add weighting to values based on the deduplication marker. For instance, if a log with ‘domain=google.com’ contains ‘logslash=100’, then the model adds 100 to the weight of ‘domain=google.com’ for that given timeframe without needing to process 100 logs to do so.

The various exemplary inventive embodiments described herein are intended to be merely illustrative of the principles underlying the inventive concept. It is therefore contemplated that various modifications of the disclosed embodiments will without departing from the inventive spirit and scope be apparent to persons of ordinary skill in the art. They are not intended to limit the various exemplary inventive embodiments to any precise form described. Other variations and inventive embodiments are possible in light of the above teachings, and it is not intended that the inventive scope be limited by this specification, but rather by the claims following herein.

Although the present invention has been described in detail with reference to certain preferred configurations thereof, other versions are possible. Embodiments of the present invention can comprise any combination of compatible features shown in the various figures, and these embodiments should not be limited to those expressly illustrated and discussed. Therefore, the spirit and scope of the invention should not be limited to the versions described above. Moreover, it is contemplated that combinations of features, elements, and steps from the appended claims may be combined with one another as if the claims had been written in multiple dependent form and depended from all prior claims. Combination of the various devices, components, and steps described above and in the appended claims are within the scope of this disclosure. The foregoing is intended to cover all modifications and alternative constructions falling within the spirit and scope of the invention.

1. A method for processing aggregated records, comprising:
receiving an aggregated record;
identifying a key-value pair within said aggregated record, wherein said key-value pair comprises a key and a value, and wherein said key comprises a deduplication marker;
identifying an aggregation method based on a characteristic of said deduplication marker; and
processing said aggregated record using an algorithm determined by said aggregation method to produce at least one processed record.

2. The method of claim 1, wherein said aggregated record is a computer log file.

3. The method of claim 1, further comprising displaying said at least one processed record.

4. The method of claim 1, further comprising utilizing said at least one processed record to train an artificial intelligence model.

5. The method of claim 1, wherein said characteristic of said deduplication marker is a field name, an identifier, or a configuration.

6. The method of claim 1, wherein said at least one processed record comprises a plurality of identical records which are duplicated based on said value of said key-value pair.

7. The method of claim 1, wherein said key-value pair is a deduplication marker key-value pair.

8. The method of claim 1, wherein said key-value pair is a target key-value pair.

9. A system for processing aggregated records, comprising:
a memory storing computer-readable instructions; and
at least one processor communicatively coupled to said memory, wherein said computer-readable instructions, when executed by said at least one processor, cause said at least one processor to perform operations comprising:
receiving an aggregated record;
identifying a key-value pair within said aggregated record, wherein said key-value pair comprises a key and a value, and wherein said key comprises a deduplication marker;
identifying an aggregation method based on a characteristic of said deduplication marker; and
processing said aggregated record using an algorithm determined by said aggregation method to produce at least one processed record.

10. The system of claim 9, wherein said aggregated record is a computer log file.

11. The system of claim 9, further comprising displaying said at least one processed record.

12. The system of claim 9, further comprising utilizing said at least one processed record to train an artificial intelligence model.

13. The system of claim 9, wherein said characteristic of said deduplication marker is a field name, an identifier, or a configuration.

14. The system of claim 9, wherein said at least one processed record comprises a plurality of identical records which are duplicated based on said value of said key-value pair.

15. The system of claim 9, wherein said key-value pair is a deduplication marker key-value pair.

16. The system of claim 9, wherein said key-value pair is a target key-value pair.

17. A set of machine-readable instructions embedded in a tangible medium for causing a machine to perform the steps, comprising:
receiving an aggregated record;
identifying a key-value pair within said aggregated record, wherein said key-value pair comprises a key and a value, and wherein said key comprises a deduplication marker;
identifying an aggregation method based on a characteristic of said deduplication marker; and
processing said aggregated record using an algorithm determined by said aggregation method to produce at least one processed record.
